(19) United States
(12) Patent Application Publication
(10) Pub. No.: US 2005/0076225 A1
(43) Pub. Date: Apr. 7, 2005

(54) Method and apparatus for verifying the intergrity of system data

(76) Inventors: Johan Cornelis Talstra, Eindhoven (NL); Antonius Adriaan Maria Staring, Eindhoven (NL)

Correspondence Address: U S Philips Corporation;Intellectual Property Department, P O Box 3001, Briarcliff Manor, NY, 10510, US

(21) Appl. No.: 10/497,335

(22) PCT Filed: Dec. 2, 2002
(86) PCT No.: PCT/IB02/05114

(30) Foreign Application Priority Data
Dec. 5, 2001 (GB) 0129065.9

(51) Int. Cl. H04L 9/32

(52) U.S. Cl. 713/187; 713/176

(57) ABSTRACT

The present invention relates to a method of verifying the integrity of system data, particularly of copy protection information like an Effective Key Block or a Media Key Block including revocation data for revoking untrusted devices. At present cryptographic information relating to content-protection is prerecorded on disks. In order to avoid that this information is changed which poses a security risk, a cryptographic hash of the cryptographic information is stored on the disk in read-only manner according to a known method. However, the processing according to a known method is slow and increases the start-up time. This problem is solved according to the present invention by a method of verifying the integrity of system data, comprising the steps of: generating a cryptographic key from said system data, generating check data from said cryptographic key using a hash function, and verifying the integrity of said system data by comparing the generated check data with a trusted version of said check data. The invention further refers to a method generating such check data, to corresponding apparatuses, to a storage medium and to a computer program.

The invention relates to a method of verifying the integrity of system data, to a method of generating check data for verifying the integrity of system data, to corresponding apparatuses, to a storage medium for storing data and to a computer program.

Recently optical media standards like DVD-RW, DVD-RAM, DVD+RW and DVR have started to adopt revocation. Revocation is a mechanism whereby recorders or players of which it has become known that they have been hacked, can be disabled. This is effectuated by mastering a block of information known alternately as Media Key Block (MKB) and Effective Key Block (EKB) into the blank media which may be rewriteable or recordable. EKBs are particularly known from WO 01/78298 A1 and WO 01/78299 A1, which are incorporated herein by reference. Such key blocks contain information which a recorder or player needs to encrypt user data such as music, film or software onto such blank media. If a particular device is known to be hacked the key block on new blank media will be changed such that such a device can no longer use it, but all other devices can. In the following, reference will only be made to EKB, meaning however both MKB and EKB, unless noted otherwise.

The EKB device revocation structure is completely based on symmetrical cryptography, which is advantageous for simple (i.e. cheap) devices. Another advantage of the EKB is that due to its well-structured design, its size is small if only a small number of devices are revoked. It is only if a large number of devices are revoked that the EKB becomes large (in contrast to, e.g., CPRM's MKB, which can grow to its maximum size if only one or two devices are revoked).

A disadvantage of the EKB structure is that it becomes relatively easy for an attacker to create a forged EKB if a sufficient (small) number of devices have been hacked, i.e. the set of device keys that is unique for a particular device has become public. The problem therefore is, how to distinguish a real EKB from a forged one, especially in the case of EKBs that are stored on recordable or rewriteable media. A solution is to include a digitally signed hash of the complete EKB in its header part, which renders any bit change(s) detectable to devices that perform a digital signature check. However, it has to be noted that this digital signature is created by the authority that maintains the EKB system.

Technically speaking it is a major challenge to produce optical disks having such pre-mastered information in such a way that the key block does not interfere with the normal usage of the disk. It is difficult to simultaneously optimise ease of use for both the media-manufacturer and the recorder-manufacturers. One exemplary technology is to “pre-emboss” the key block on empty disks. Such key blocks are easy to read out in devices, but the disks are expensive to make due to low yield and suffer from lower write-quality. On the other hand, techniques like recording the key block into a sub-channel like a wobble makes for cheap, high quality media, but read-out is very slow since such a wobble is a low data-channel.

European Patent Application with application number 00201951.1 (PHNL 000 303 EPP) describes a recording apparatus for storing data on a re-writeable data storage medium. Therein it is proposed that the first recorder to access a blank disk would copy the key block in the low data-rate sub-channel to a normal data-area or the lead-in area of the disk. It should be noted that in that document the key block is referred to as system data. Subsequent devices requiring access to this disk could then access the key block using the ordinary high data-rate channel, which is often referred to as HF-channel, i.e. the high frequency channel into which normal user data is written. In another implementation the key block would already be written in the HF-channel by the media manufacturer. It is furthermore stipulated that there is a threat that hackers will try to erase the present key block in the HF-channel (disk is rewriteable) and will replace it by an old key block since newer key blocks obviously contain more revoked devices than old ones. A solution proposed for this problem is to compute a cryptographic hash or signature over the key block storing this signature in a part of the disk, which cannot be changed under control of the user, e.g. in a wobble or an (N)BCA. Such area is often referred to as a RO (read-only) sub-channel.

An issue with this solution is that all devices seeking access to the key block first have to compute such a signature and verify it against the signature as contained in the read-only sub-channel. Such a computation can be relatively costly in terms of additional hardware, but mostly in additional start-up time. Modern drives already have almost unacceptably long start-up times (order of 20 sec.) to which said signature verification only adds.

It is therefore an object of the present invention to provide a solution for overcoming said problems, which in particular overcomes this start-up time problem but also provides a high level of protection against hacking and allows a highly reliable verification of the integrity of system data like the above described key blocks.

This object is achieved by a method of verifying as claimed in claim 1 and by an apparatus for verifying as claimed in claim 11. This object is further achieved by a method of generating check data for verifying the integrity of system data as claimed in claim 10 and a corresponding apparatus as claimed in claim 13. A storage medium for storing data and a computer program which both solve the above object and in which the present invention is implemented are further claimed in claims 14 and 15.

The present invention is mainly based on'the idea that according to the present use of the system data a cryptographic key is already generated anyway. This cryptographic processing, which is already part of the normal start-up procedure, can—with minor additions—be made equivalent to computing a hash. In other words, a cryptographic key is generated which is necessary anyway and the check data which are generated from such cryptographic key using a hash function can be archived very easily. If a hacker had changed the system data, the resulting cryptographic key would then have changed, resulting then also in a different version of check data compared to check data finally achieved from original system data.

In order to verify the integrity of said system data it is therefore in addition proposed according to the present invention that a trusted version of said check data is prepared and provided for verification by comparing the generated check data with the trusted version of said check data. Said trusted version of check data is generated from the original system data or directly from the cryptographic key. If a hacker had changed the system data the comparison between the generated check data and the trusted version of said check data would then lead to inequality allowing to detect the change of the system data.

The generation of the trusted version of said check data is preferably implemented by a media manufacturer who uses a suitable hash function for generating the check data from the cryptographic key which is a secret key, preferably for encrypting/decrypting user data to be stored on a record carrier like a CD or DVD. The generation of said trusted version of the check data can also be implemented in a trusted third party like a key licensing authority providing cryptographic keys for encryption and decryption which will then use a suitable hash function and provide the trusted check data in encrypted or decrypted form for verification. Said check data may then be transmitted over a network like the Internet or a telephone network to the device actually requiring the trusted version of such check data for verification.

Preferred embodiments of the method of verifying the integrity of system data are included in the dependent claims. It should be noted that the method of generating the check data, the apparatuses, the storage medium and the computer program according to the present invention can be developed further and can have similar or identical embodiments as included in said dependent claims.

In a preferred embodiment the trusted version of said check data is obtained from a record carrier, in particular read from a record carrier storing said trusted version in a read-only area or channel. If a device like a player or recorder tries to access the record carrier it is then able to check the integrity of system data, preferably stored in a recordable area of said record carrier by using said trusted version of check data which cannot be changed by a user. If this integrity check leads to a negative result i.e. if a change of the system data may have happened, the access can be denied. The trusted version of said check data will then preferably be generated and recorded on said record carrier by the the media manufacturer or another trusted third party.

Alternatively, a trusted version of said check data is received from a trusted third party, in particular received from a licensing authority via a network, in particular via the internet. This embodiment is preferably used when using a computer for accessing a record carrier. The computer which is linked to the internet will then be able to receive the trusted version of said check data via the internet so that the computer can verify the integrity of system data which may be either stored on the record carrier or which may also be received via the same or another network simultaneously or separately from said third party. Preferably the system data are received simultaneously with the trusted version of the check data via the internet from the same licensing authority.

Further, preferably an elliptic curve signature of a one-way hash of the cryptographic key generated from the system data is computed and appended to the system data for transmission to the requesting device. The trusted version of the check data may thereby be in encrypted or decrypted form, the first case requiring another step of decryption before using it for verifying the integrity of the system data.

It is preferred that the hash function which constitutes the check data from the cryptographic key is a one-way function in the cryptographic key in the sense that it should be easy to compute the check data but very hard to compute the cryptographic key from said check data. Otherwise, a hacker could just read out the check data and compute the cryptographic key and get access to all the encrypted content on the disk which he shouldn't have access to. The hash function may also be an encryption function having a fixed input using the cryptographic key as key for encryption. Preferably, the fixed input to that hash function is obtained from a record carrier, in particular read from a record carrier storing input in a read-only area or channel.

Generally, the system data may be any kind of data the integrity of which shall be checked. A preferred application lies in the field of copy-protection. Therefore, the system data include preferably copy-protection data, in particular revocation data such as an Effective Key Block or a Media Key Block for revoking untrusted devices such as playback devices, recording devices or copy devices, in particular for playback, recording or copying of optical record carriers as used in CD-, DVD- or DVR-technology. Thus, copy-protection information can preferably be distributed through rewriteable disks which may then contain a list of recorders or monitors which a PC should no longer send movies to using the DVI interface.

If said trusted version of said check data includes part of the system data, particularly the quite small descriptive part of an EKB, as proposed according to another embodiment, a still higher level of protection against hacking can be achieved, i.e. forging of an EKB from a cryptographic key can be prevented. Said trusted version of said check data may also comprise a hash-function of the cryptographic key and at least part of copy-protection data, in particular the descriptive part of said EKB.

The invention is preferably applied in an apparatus for playback and/or recording an optical record carriers storing system data comprising:
means for reading said system data from said record carrier,
an apparatus for verifying according to claim 9, and
means for stopping playback and/or recording depending on the result of verification received from said apparatus for verifying.

A storage medium for storing data, which is preferably an optical record carrier, comprises:
a recordable data area storing system data, in particular copy protection data for revocation of untrusted devices, and
a read only data area storing check data for verifying of system data, said check data being generated from a cryptographic key using a hash function and being used for verifying the integrity of said system data by comparing the check data with a trusted version of said check data and said cryptographic key being generated from said system data.

The input to the hash function may also be stored in said read-only data area. Further, the check data is preferably fixed through the standard.

The invention will now be explained in more detail with reference to the figures, in which

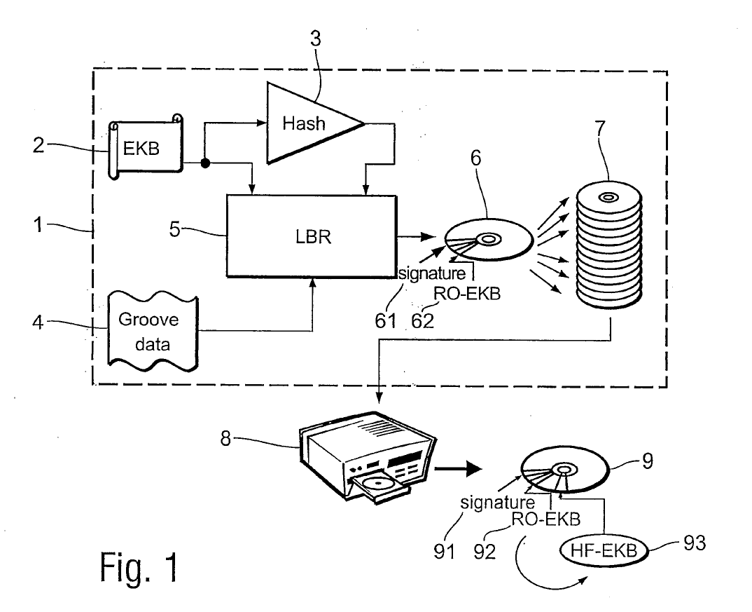

FIG. 1 illustrates the known method for recording data on optical record carriers,

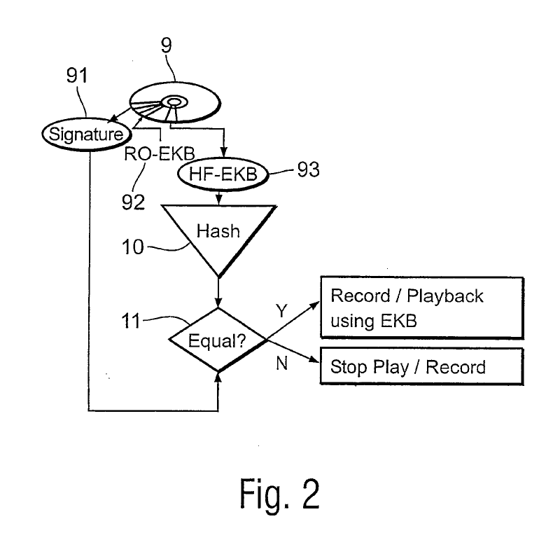

FIG. 2 illustrates the known method for verification,

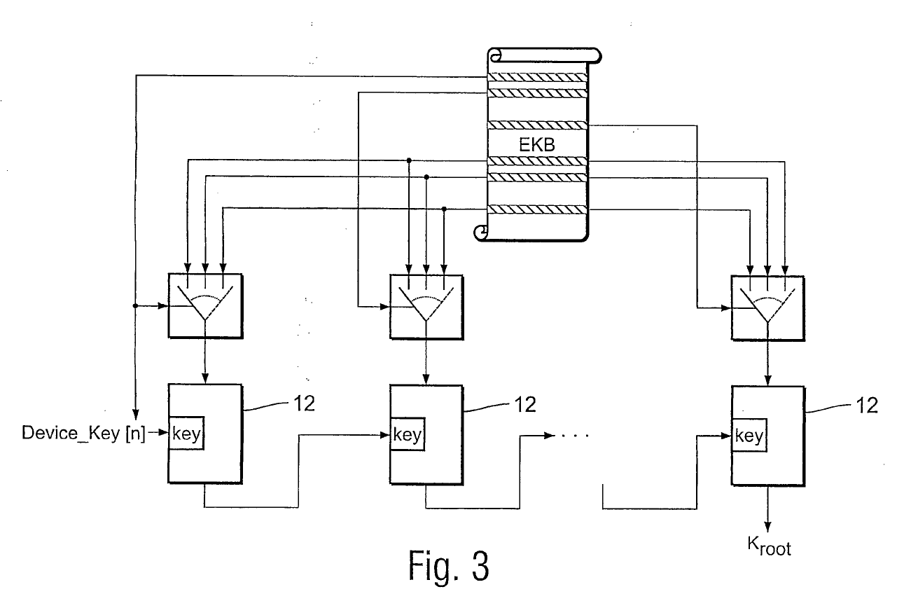

FIG. 3 shows the generation of a cryptographic key,

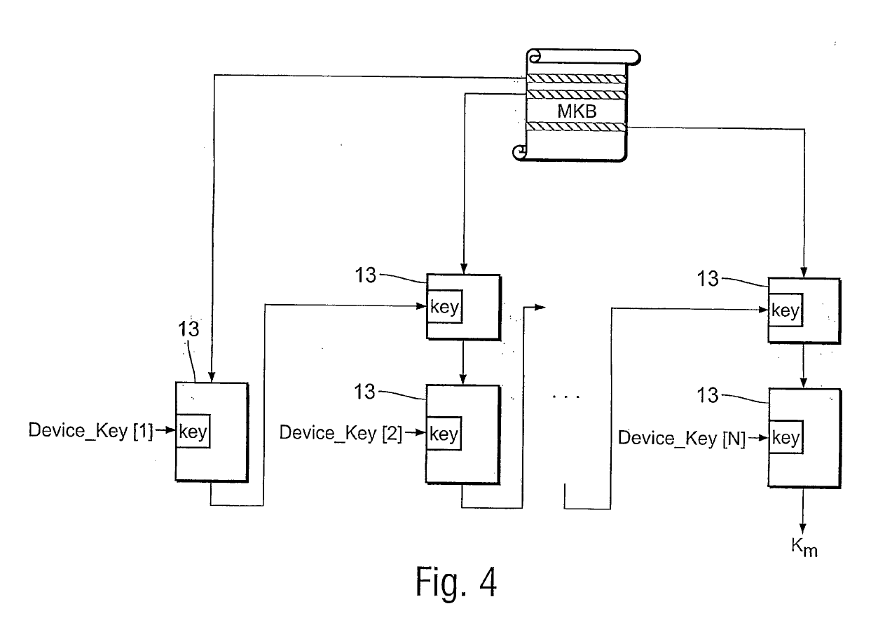

FIG. 4 shows another method for generation of a cryptographic key,

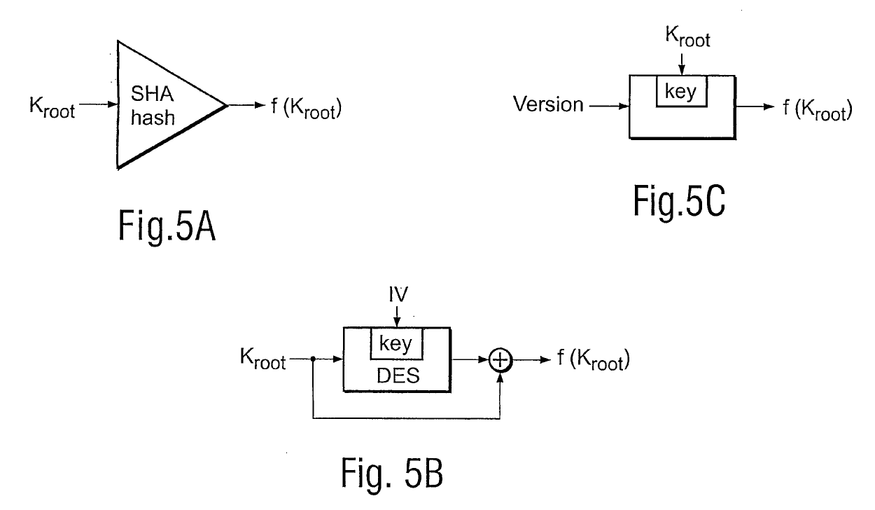

FIG. 5 shows different ways to generate the check data,

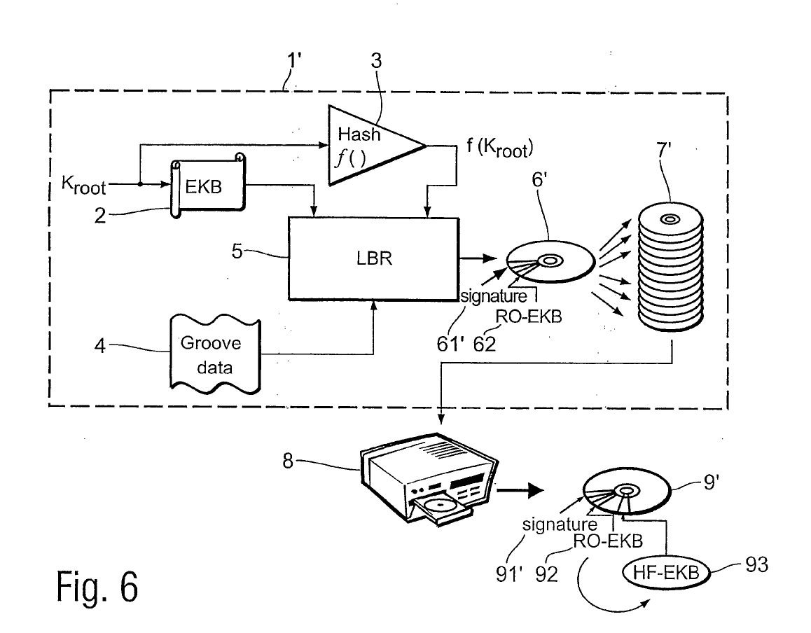

FIG. 6 illustrates a method of recording according to the present invention,

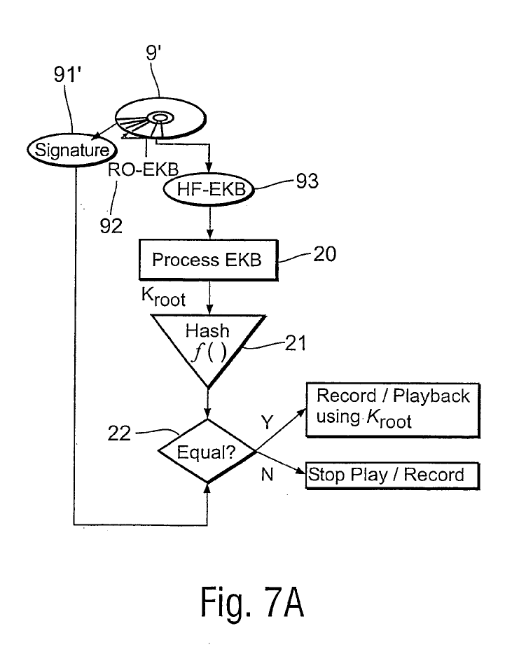

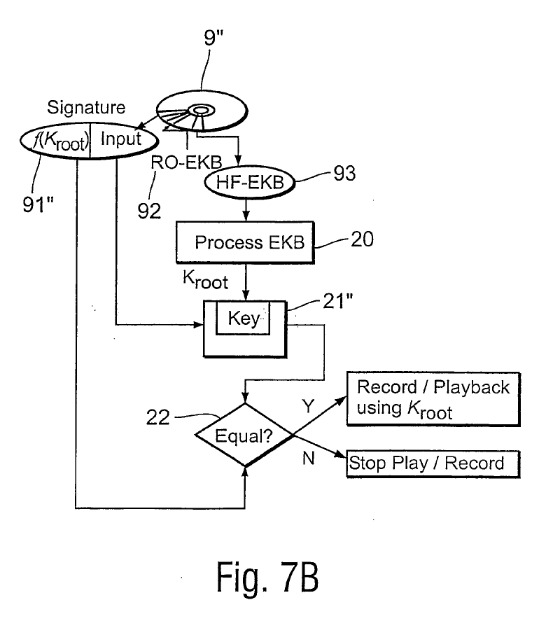

FIGS. 7a, 7b illustrate different embodiments of a method of verifying according to the present invention and

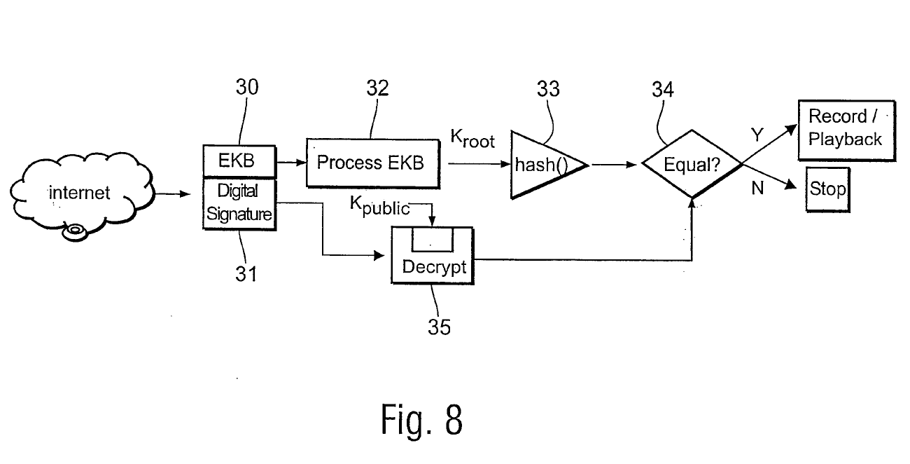

FIG. 8 illustrates another embodiment of verifying according to the present invention.

FIG. 1 shows a block diagram illustrating the method of generating a blank recordable disk as well as the subsequent step implemented in the first recorder accessing the blank disk. In the media factory 1 the blank optical disks with pre-mastered information are produced. This information includes an Effective Key Block (EKB) 2 or, alternatively and not shown, a Media Key Block (MKB) containing information which a recorder or player needs to encrypt data onto or decrypt data from such blank recordable media. Said EKB 2 is recorded into a read-only subchannel by using a wobble which is a very low data-rate, channel. By the Laser Beam Recorder 5 (LBR) first a master disk 6 is produced from which thereafter the blank rewriteable disks 7 will be pressed. As can be seen with the master disk 6, the EKB 2 is recorded in a read-only area 62 (RO-EKB) of the master disk 6. The first recorder 8 to access a blank disk 9 which is any one of the disks 7 would then copy the EKB from the low data-rate subchannel 92 to the normal data-area 93 or the lead-in area of the disk 9, referred as to the high frequency (HF) channel. Subsequent devices requiring access to this disk 9 could then access the EKB using the ordinary high data-rate channel 93 instead of the low data-rate sub-channel 92.

Since there is a threat that hackers will try to erase the EKB in the HF channel 93 and replace it by an old EKB, a cryptographic hash or signature, i.e. check data for verification, over the EKB 2 are generated by use of a hash function 3, and store this signature in a part of the master disk 6 and thus also in the blank disks 7 and 9 which cannot be changed under control of the user, e.g. in a wobble or an (N)BCA, in general in a read-only subchannel 61 and 91, respectively.

In addition, the LBR 5 uses groove data 4 containing certain information to be pre-pressed on the blank disks 7 and 9 like address information, a disc manufacturer identification and optical recording parameters. Said groove data may be encoded by a back and forth motion along the spiral groove of the disk which is often referred to as the wobble.

A known method of verifying the integrity of system data, i.e. of the EKB 2 stored in the high data-rate channel 93 on the blank disk 3 as explained with reference to FIG. 1, is shown in FIG. 2. Said method is implemented on recorders or players requesting access to the disk 9. According to this known method the EKB stored in the high data-rate channel 93 is read from the disk 9. Thereafter check data are generated from said EKB by applying a hash function. These check data are compared to the signature stored in the read-only data channel 91 on the disk 9 in a compare step 11. Provided that the EKB has not been changed the generated check data and the signature will be equal thus allowing the device to access the disk 9 while in the other case access is denied, i.e. playback or recording may be stopped.

According to the known solution all devices seeking access to the EKB first have to compute such a signature and verify it against the signature as contained in the RO sub-channel. This computation can be relatively costly in terms of additional hardware, but mostly in additional start-up time. The present invention therefore provides a solution for this start-up time problem.

Before explaining the invention in detail a short introduction to the use of key blocks by way of example of an EKB shall be given. The outcome of the normal processing of an EKB is a secret key, generally known as root_key kᵣₒₒₜ in EKBs and as media_key Kₘ in MKBs. In the following the EKB nomenclature shall be used. This cryptographic key is used to encrypted or decrypted the music/film on the disk. In order to obtain the cryptographic key the device has to decrypt a small part of the EKB using its so called device_node_keys (EKB) or device_keys (MKB). Each device has a small number of such keys (in the order of 16-32), out of a potentially very large set. It should be noted that each device has another unique sub-set of such keys. If it is decided to revoke a particular device, the part of the EKB which can be decrypted using the device_node_keys of the revoked device is left empty or made to contain invalid information. Consequently such a device can no longer use the EKB and doesn't obtain the cryptographic key Kᵣₒₒₜ to encrypt or decrypt content.

The generation of the cryptographic key Kᵣₒₒₜ from the Effective Key Block EKB by use of device_node_keys is shown in FIG. 3. The generation of the cryptographic key Kₘ from the Media Key Block MKB by use of device_keys is shown in FIG. 4. It should be noted that the boxes 12 and 13 represent a decryption function. Since an EKB or MKB can be very large, in the order of 100 KB to 15 MB, it is immediately clear that computation of the cryptographic signature of the EKB or MKB is costly in time and hardware.

In FIGS. 3 and 4 it can be seen that the device already processes a part of the EKB/MKB in a cryptographic manner. It has been found that with minor additions this cryptographic processing which is already part of the normal start-up procedure can be made equivalent to computing a hash. In other words the device computes the cryptographic key which is necessary anyway and gets the hash-value of the EKB without any additional effort. However, if a hacker had changed the MOB or EKB, the resulting cryptographic key would have changed. Therefore it is proposed according to the present invention that the media manufacturer chooses a signature e.g. generates check data, which is a function of the cryptographic key. In that case, if the EKB/MKB, i.e. the system data, has been replaced, the signature will be no longer consistent with the value of the cryptographic key as computed from such EKB/MKB. It is essential that this function which constitutes the signature is a one-way function in the cryptographic key in the sense that it should be easy to compute the signature but very bard to compute a cryptographic key from only knowing the signature. Otherwise a hacker could just read out the signature and compute the cryptographic key and get access to the encrypted content on the disk which should be prevented.

Different examples of hash functions for generating the signature from the cryptographic key are shown in FIG. 5. According to FIG. 5a a good cryptographic one-way hash function, like MD 4, MD 5 or SHA is u sed. According to FIG. 5b a good cipher used as a one-way hash function, like DES, AES etc. is used. This is sometimes more useful because an encryption function is usually already present in the unit processing the EKB. IV stands for Initial Vector and is some random 64 or 128 bits string. According to FIG. 5c a cipher is used where the cryptographic key Kᵣₒₒₜ is used as the key and a publicly known text as data input. It is, required that the input is fixed meaning that the signature-checking device has to be certain what this input is. Therefore, the input may be either agreed as part of the standard, e.g. as certain text, or the input may be written into the read-only sub-channel in which also the signature is stored. In other words, the signature really consists of both the input and the signature. In the particular example shown in FIG. 5c the version number of the EKB is used as the random plain-text.

The method of generating check data for verification as well as generating a blank formatted disk according to the invention is illustrated in FIG. 6. In contrast to the known method as illustrated in FIG. 1 the signature f(Kᵣₒₒₜ) is not generated in the EKB 2 but from the cryptographic key Kᵣₒₒₜ which is much easier and faster to do since the cryptographic key is much shorter than the EKB 2. By use of the cryptographic key Kᵣₒₒₜ which is given by the media manufacturer 1′, the EKB 2, i.e. the system data, are generated. Both, the signature 61′, i.e. the trusted version of the check data, and the EKB 62 are stored in a read-only area or sub-channel on the master disk 6′ from which the blank disks 7′ are produced. Similar to the known method the first recorder 8 will then copy the EKB 92 of a single blank disk 9′ to a recordable area or channel 93.

Different embodiments of the method of verifying the integrity of system data are shown in FIGS. 7a and 7b. Contrary to the known method as shown in FIG. 2 according to the invention the device first processes the EKB read from the recordable area or channel 93 (step 20) thus generating the cryptographic key Kᵣₒₒₜ. From said cryptographic key check data are generated by using a hash function 21. It should be noted that the hash function 21 can be implemented in different ways as shown in FIG. 5. The generated check data are thereafter compared in step 22 to the signature 91′ which is a trusted version of the checke data stored in the read-only sub-channel or area on the disk 9′. Depending on the result of this verification access to the disk 9 is granted or is denied. In FIG. 7b it is understood that either the left part of signature 91″, i.e. f(Kᵣₒₒₜ), or the right part (input) do not have to be recorded on the disk, but can be separately agreed in the disk standard.

The method as shown in FIG. 7a shall be illustrated by way of an example for DVD+RW where it is considered to implement an MKB instead of an EKB. For DVD+RW the hash function f( ) is of the kind as shown in FIG. 5c with as input the text “0xDEADBEEF” with appropriate padding and as cipher the so called C2_D function. As RO sub-channel for the signature 91′ the NBCA (Narrow Bust Cut Area) will be used. This implementation has the advantage that the encryption which is part of the generation of the check data as shown in FIG. 5c has to happen as part of the normal MXB-processing anyway. Preferably, the start-up burden is lowered by avoiding to perform a full hash of the MKB as it is done in the known method.

The modified method as shown in FIG. 7b is explained by way of an example for DVR where the hash function is of the kind as shown in FIG. 5c with as input the EKB-version field (version number) and as the signature 91″ the encrypted_version( ) field. The RO sub-channel for both the RO-EKB 92 and the signature 91″ will be the so called PIC-band. This implementation has the advantage that no new fields or sub-channels have to be defined in the format, since all these fields/channels are already present in DVR right now. Also the encryption step 21″ is already part of the current DVR-standard, so that the only additional burden of this method to a recording device is a simple 16-bit compare. Compared to the required hashing of the full 12,5 M bytes EKB as required according to the known method it is immediately clear that the method according to the invention drastically reduces the required time needed for verification of the integrity of system data.

In a new CD-standard the EKB is not necessarily pre-mastered by the media-manufacturer, but can also be transmitted over networks. To avoid tampering in transition, the EKB has been signed by a EKB licensing authority using an elliptic-curve signature. A recording or playback device receiving such an EKB would have to hash the EKB, check the hash against an elliptic-curve signature of the hash which is appended to the EKB and process the EKB in a normal manner to obtain a cryptographic key Kᵣₒₒₜ if the check gives a positive result. The elliptic curve signature is the equivalent of the RO sub-channel described above. However, again for cheap CD devices it is a burden to have to compute the hash over a large amount of data.

Similarly as described above, it is possible to avoid computing such a hash by applying the following procedure according to the present invention. The transmitter of the EKB, i.e. a trusted third party like an EKB licensing authority, first processes the EKB in a normal manner to obtain the cryptographic key Kᵣₒₒₜ. Thereafter it computes the elliptic-curve signature of a one-way hash Kᵣₒₒₜ. This signature is then appended to the EKB for transmission to a recording or playback device. Again, it can be chosen from the different possibilities for generating a hash of the cryptographic key Kᵣₒₒₜ shown in FIG. 5. Particularly interesting is a hash value consisting of version E(Kᵣₒₒₜ, version). The reason is that this number has to be computed anyway as part of the EKB-processing.

The method of verifying the integrity of the EKB received via the internet by a receiving device, for example implemented on a PC is shown in FIG. 8. Therein the EKB 30 is processed in the normal manner (step 32) to obtain the cryptographic key K to which key thereafter a one-way hash 33 is applied generating the check data. In parallel the digital signature 31 generated by the trusted third party and transmitted in parallel to the EKB 30 which inherently includes the trusted check data is decrypted in step 35 by use of the public key K_{public} generating the trusted check data. These are thereafter compared (step 34) to the generated check data for verification of the integrity thereof. Depending on the result, access to certain data, e.g. stored on a record carrier, can be denied or granted.

The signature method described above effectively prevents hacks where EKBs are replaced by other EKBs with another Kᵣₒₒₜ. This means the hacker can no longer overwrite new EKBs by old EKBs. If a hacker has enough knowledge to forge an EKB with the same Kᵣₒₒₜ the signature in a RO sub-channel will be consistent even with the hacked EKB. However, in order to do such a thing, a hacker needs knowledge of a substantial number of device_node_keys because (s)he doesn't know a priori which device will use his hacked EKB. Presumably these are obtained by hacking other devices.

Due to its structure, the number of hacked devices required is substantially lower in case of an EKB than in case of a MKB. However, by slightly increasing the information contained in the signature it is possible to obtain protection to this hack as well. In order to understand how this works, it is necessary to know that the EKB can be split into roughly two parts, namely a descriptive part and a data part. The data part contains the actual information with respect to renewed decryption keys, while the descriptive part indicates how the data part is to be interpreted. For example it informs devices which device_node_keys shall be used to start the decryption chain that leads to Kᵣₒₒₜ. Typically, the size of this descriptive part is only a few percent of the total EKB size. By fixing the descriptive part, i.e. by adding it to the signature described in the foregoing, a hacker is effectively blocked to create a forged EKB.

1. Method of verifying the integrity of system data, comprising the steps of:
generating a cryptographic key from said system data,
generating check data from said cryptographic key using a hash function, and
verifying the integrity of said system data by comparing the generated check data with a trusted version of said check data.

2. Method according to claim 1, wherein said trusted version of said check data is obtained from a record carrier, in particular read from a record carrier storing said trusted version in a read-only area or channel.

3. Method according to claim 1, wherein said trusted version of said check data is received from a trusted third party, in particular received from a licensing authority via a network, in particular via the internet.

4. Method according to claim 3, wherein said trusted version of said check data is received from said third party in encrypted form and is first decrypted before comparing it with the generated check data.

5. Method according to claim 1, wherein said hash function is a one-way hash function.

6. Method according to claim 1, wherein said hash function is an encryption function having a fixed input.

7. Method according to claim 7, wherein said fixed input is obtained from a record carrier, in particular read from a record carrier storing input in a read-only area or channel.

8. Method according to claim 1, wherein said system data include copy-protection data, in particular revocation data such as an Effective Key Block or a Media Key Block for revoking untrusted devices such as playback devices, recording devices or copy devices, in particular for playback, recording or copying of optical record carriers.

9. Method according to claim 8, wherein said cryptographic key is used for encrypting and/or decrypting user data.

10. Method according to claim 8, wherein said trusted version of said check data includes at least a part of said copy-protection data, in particular the descriptive part of said Effective Key Block.

11. Method according to claim 7, wherein said trusted version of said check data comprises a hash function of the cryptographic key and at least part of said copy-protection data, in particular the descriptive part of said Effective Key Block.

12. Method of generating check data for verifying the integrity of system data, comprising the steps of:
generating a cryptographic key from said system data,
generating check data from said cryptographic key using a hash function, and
providing said check data for storage version in a read-only area or channel on a record carrier storing said system data or transmission via a transmission line.

13. Apparatus for verifying the integrity of system data, comprising:
means for generating a cryptographic key from said system data,
means for generating check data from said cryptographic key using a hash function, and
means for verifying the integrity of said system data by comparing the generated check data with a trusted version of said check data.

14. Apparatus for playback and/or recording of optical record carriers storing system data comprising:
means for reading said system data from said record carrier,
an apparatus for verifying according to claim 13, and
means for stopping playback and/or recording depending on the result of verification received from said apparatus for verifying.

15. Apparatus for generating check data for verifying the integrity of system data, comprising:
means for generating a cryptographic key from said system data,
means for generating check data from said cryptographic key using a hash function, and
means for providing said check data for storage version in a read-only area or channel on a record carrier storing said system data or transmission via a transmission line.

16. Storage medium for storing data comprising:
a recordable data area storing system data, in particular copy protection data for revocation of untrusted devices, and
a read-only data area storing check data for verifying the integrity of system data, said check data being generated from a cryptographic key using a hash function and being used for verifying the integrity of said system data by comparing the generated check data with a trusted version of said check data and said cryptographic key being generated from said system data.

17. Storage medium according to claim 16, wherein said read-only data area further stores the input to said hash function and wherein said check data is fixed through the standard.

18. Computer program comprising program code means for causing a computer to perform the method of claim 1.
